(19) United States
(12) Patent Application Publication
(10) Pub. No.: US 2003/0165673 A1
(43) Pub. Date: Sep. 4, 2003

(54) Laminate containing foamed polyethylene resin

(76) Inventors: Kouki Fukui, Takatsuki-shi (JP); Isao Kurimoto, Takatsuki-shi (JP); Susumu Okairi, Takatsuki-shi (JP); Nobuo Shindo, Takatsuki-shi (JP); Masahiko Ogake, Takatsuki-shi (JP); Tsuyoshi Sugauchi, Takatsuki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/373,701

(22) Filed: Feb. 27, 2003

(30) Foreign Application Priority Data
Feb. 27, 2002 (JP) 2002-51856

(51) Int. Cl. B32B 27/00

(52) U.S. Cl. 428/319.3; 428/317.1

(57) ABSTRACT

An excellent laminate applicable to various uses capable of overcoming drawbacks of a foamed polyethylene resin such as weak wear resistance and weak strength, by effectively covering the surface of the foamed polyethylene resin, in which a resin layer containing a graft copolymer of an ethylene-vinyl acetate copolymer resin and a vinyl chloride resin is laminated to a foamed polyethylene resin, and a resin layer containing a graft copolymer of an ethylene-vinyl acetate copolymer resin and a vinyl chloride resin is interposed between the foamed polyethylene resin layer and the vinyl chloride resin layer.

### BACKGROUND OF THE INVENTION

1. Field of the Invention

This invention concerns a laminate containing a foamed polyethylene resin.

2. Description of the Related Art

Foamed polyethylene resins, being foamed products, are satisfactory in heat insulation and warmth retaining property and also excellent in shock absorbing performance. Further, they are light in the weight, highly flexible and are used generally for various packaging materials, lids for bath tabs, mats for bath rooms, and protection covers for cooler pipelines and city water pipes.

On the other hand, foamed polyethylene resins involve drawbacks that they are liable to suffer from scratches and wearing and also feeble in view of strength. Further, they also have a drawback of poor appearance and poor color.

As a method of compensating the drawbacks of the foamed polyethylene resins described above, surfaces of foamed polyethylene resin layers are covered with sheets or films of polyethylene resin (PE) or ethylene-vinyl acetate resin (EVA) by heat sealing.

However, mere covering by the sheet or the film of the polyethylene resin or ethylene vinyl acetate resin is not so effective to scratches or wearing. Further, heat sealing with the sheet or the film hardens the entire portion, and consequently it fails to obtain a sufficient flexibility.

In view of the above, as a method of overcoming such problems, it may be considered to seal the foamed polyethylene resin with a soft vinyl chloride resin instead of the sheet or the film of the polyethylene resin or ethylene vinyl acetate resin.

However, since the vinyl chloride resin has a polarity while the foamed polyethylene resin has no polarity, there is no compatibility between both of them. Therefore, there is a problem that both of the resins can not be bonded by heat sealing or the like.

### SUMMARY OF THE INVENTION

In view of the foregoings, the present invention intends to overcome the drawbacks of a foamed polyethylene resin such as low wear resistance and poor strength.

The invention also intends to provide an excellent laminate applicable to various uses by effectively covering a foamed polyethylene resin layer.

For attaining the foregoing purpose, in accordance with a laminate of the invention, a foamed polyethylene resin layer is laminated with a resin layer containing a graft copolymer of an ethylene-vinyl acetate copolymer resin and a vinyl chloride resin.

For attaining the same purpose, the invention provides another laminate of a foamed polyethylene resin layer and a vinyl chloride resin layer in which a resin layer containing a graft copolymer of an ethylene-vinyl acetate copolymer resin and a vinyl chloride resin is interposed between both of the resin layers.

In the invention described above, a soft material containing an appropriate amount of a plasticizer is used preferably as said resin layer containing the graft copolymer. On the other hand, a soft material containing an appropriate amount of a plasticizer is used preferably as the vinyl chloride resin layer. In this case, a soft vinyl chloride resin layer and a soft resin layer containing the graft copolymer having identical extent of flexibility are used preferably.

The resin layer containing the graft copolymer described above is poor in the heat stability when used alone and an appropriate amount of a stabilizer is incorporated desirably. Further, various kinds of additives other than the stabilizer may also be blended within such a range as not hindering adhesion between the foamed polyethylene resin layer and the vinyl chloride resin layer.

The graft copolymer resin of the ethylene-vinyl acetate copolymer resin and the vinyl chloride resin described above is excellent in compatibility with the foamed polyethylene resin or vinyl chloride resin. Accordingly, stable adhesion with less deterioration with aging can be obtained. As a result, reliable integration by lamination can be attained, for example, by heat sealing.

Further, the thickness of said foamed polyethylene resin layer is preferably larger than the thickness of said resin layer containing the graft copolymer or the thickness of the sum for the thickness of said resin layer containing the graft copolymer and that of the vinyl chloride resin layer. By increasing the thickness for the foamed polyethylene resin layer having flexibility, external forces such as impacts exerting on the resin layer containing the graft copolymer and the vinyl chloride resin layer at the outside can be shared also on foamed polyethylene resin layer at the inside. This enables to provide effective shock absorbance.

Further, other resin layer may also be interposed between the resin layer containing the graft copolymer and the foamed polyethylene resin layer. More specifically, a resin layer containing an ethylene-vinyl acetate copolymer resin is interposed.

Generally, it has been known that the ethylene-vinyl acetate copolymer resin and the graft copolymer resin of this invention have compatibility and are excellent in adhesion. Since the ethylene-vinyl acetate copolymer resin belongs to the same polyolefinic resin identical with the foamed polyethylene resin, it is also compatible with the foamed polyethylene resin. Incorporation of the resin layer containing the ethylene-vinyl acetate copolymer resin does not hinder the integration by lamination.

The laminate according to the invention can be used as lids for bath tabs, mats for bath rooms and protection covers for piles, as well as various other application uses.

### BRIEF DESCRIPTION OF THE DRAWINGS

Preferred embodiments of this invention will be described in details based on the drawings, wherein

FIG. 1 is a cross sectional view of a laminate according to a preferred embodiment of the invention;

FIG. 2 is a cross sectional view of a laminate according to another preferred embodiment of the invention; and

FIG. 3 is a cross sectional view of a laminate according to a further preferred embodiment.

### DESCRIPTION OF PREFERRED EMBODIMENTS

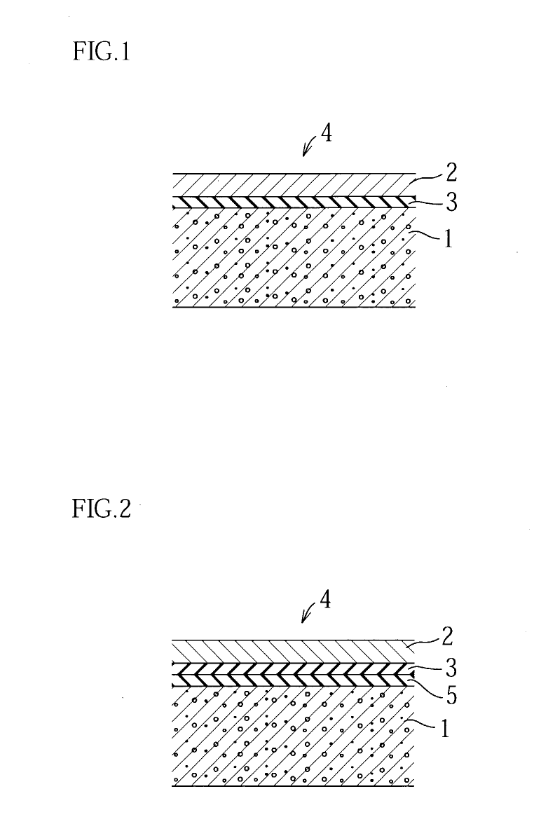

FIG. 1 shows laminated cross section of a laminate according to a preferred embodiment of the invention. In the drawing are shown a foamed polyethylene resin layer (1) and a vinyl chloride resin layer (2). The foamed polyethylene resin layer (1) is molded into a sheet of a predetermined thickness. The vinyl chloride resin layer (2) is preferably made of a soft material containing an appropriate amount of a plasticizer which is molded into a sheet or film of a predetermined thickness.

A reference numeral (3) denotes a graft copolymer resin layer formed of a copolymer of an ethylene-vinyl acetate resin and a vinyl chloride resin. The graft copolymer resin layer (3) is molded into a sheet or film-like shape of a predetermined thickness and incorporated between the foamed polyethylene resin layer (1) and the vinyl chloride resin layer (2). The graft copolymer resin (3) is made of a soft material containing an appropriate amount of a plasticizer, and it is particularly preferred to have an identical extent of flexibility with that of the vinyl chloride resin layer (2).

By interposing the graft copolymer resin (3) as described above, heat fusion using heat sealing or the like is possible, which can solve the existent problem of the adhesion between the vinyl chloride resin layer (2) and foamed polyethylene resin layer (1), to obtain a completely integrated laminate (4).

As described above, the graft copolymer resin layer (3) formed of the ethylene-vinyl acetate copolymer resin and the vinyl chloride resin is weak against heat when used alone. Accordingly, a resin layer (3) containing an appropriate amount of a stabilizer is preferably used and, further, various kinds of other additives may be blended by appropriate amounts within a range not deteriorating the compatibility between the foamed polyethylene resin layer (1) and the vinyl chloride resin layer (2).

In the laminate (4), external forces such as impacts exerting on the vinyl chloride resin layer (2) at the outside are shared sufficiently also on the soft foamed polyethylene resin layer (1) at the inside. Then, the thickness of the foamed polyethylene resin layer (1) is made much larger than the thickness of the sum for the vinyl chloride resin layer (2) and the graft copolymer resin layer (3) so that the external forces can be dispersed and absorbed in the entire laminate (4).

FIG. 2 shows a laminated cross section of a laminate according to another preferred embodiment. A layer (5) comprising a copolymer resin of an ethylene-vinyl acetate copolymer resin is interposed between the graft copolymer resin layer (3) and foamed polyethylene resin layer (1) described above. The thickness for the ethylene-vinyl acetate copolymer resin layer (5) is made substantially equal to the thickness for the graft copolymer resin layer (3).

As described above, the ethylene-vinyl acetate copolymer resin belongs to a polyolefinic resin like the graft copolymer resin and the foamed polyethylene resin. Accordingly, the ethylene-vinyl acetate copolymer resin has good compability with the graft copolymer resin and the foamed polyethylene resin. Therefore, interposition of the ethylene-vinyl acetate copolymer resin layer described above does not deteriorate the adhesion. Other constitutions are identical with those of the laminate shown in FIG. 1.

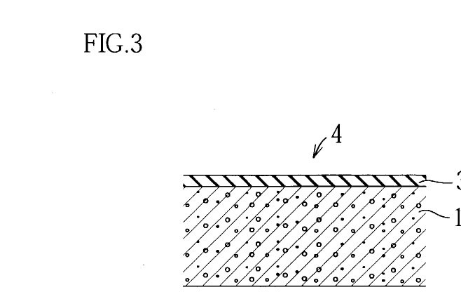

FIG. 3 shows a laminated cross section of a laminate according to a further preferred embodiment. The laminate (4) has a constitution of laminating only the graft copolymer resin layer (3) without laminating the vinyl chloride resin layer (2) to the foamed polyethylene resin layer (1).

Since the graft copolymer resin layer (3) also has flexibility and can function by itself as a protection cover for the foamed polyethylene resin layer (1), it is possible to adopt a constitution without the use of the vinyl chloride resin layer (2).

In the laminate (4), the external forces such as impacts exerting on the graft copolymer resin layer (3) at the outside are sufficiently shared also on the soft foamed polyethylene resin layer (1) at the inside. Then, the thickness for the foamed polyethylene resin layer (1) is made much larger than the thickness for the graft copolymer resin layer (3) so that the external forces can be dispersed and absorbed in the entire laminate (4).

Other constitutions are identical with those of the laminate shown in FIG. 1. Further, in the laminate (4) of a two-layered structure comprising the foamed polyethylene resin layer (1) and the graft copolymer resin layer (3), the ethylene-vinyl acetate copolymer resin layer (5) as described above may also be interposed between both of the resin layers (1) and (3).

Table 1 shows compositions and thickness for each of the layers of 8 types of test specimens prepared by bonding foamed polyethylene resin layers (PE-foam layer) and soft vinyl chloride resin layers (S-PVC layer) by using various kinds of adhesives. Particularly, test specimens shown in Examples 1 to 4 correspond to the laminate of the invention. That is, in the test specimens, resin layers containing the graft copolymer of the ethylene-vinyl acetate copolymer resin and the vinyl chloride resin (EVA-PVC graft copolymer) are used as the adhesive layers.

TABLE 1
Composition and thickness for each layer of test specimen

| | S-PVC layer | Adhesive layer | PE-foam layer |
|---|---|---|---|
| Example 1 | a formulation (0.5 mm) | A formulation (0.2 mm) | PE-foam layer (3 mm) |
| Example 2 | a formulation (0.5 mm) | B formulation (0.2 mm) | PE-foam layer (3 mm) |
| Comp. | a formulation (0.5 mm) | Hot-melt type adhesive (0.2 | PE-foam layer (3 mm) |
| Example 1 | | mm) | |
| Comp. | a formulation (0.5 mm) | Vinyl chloride type adhesive | PE-foam layer (3 mm) |
| Example 2 | | (N/A) | |
| Example 3 | b formulation (0.5 mm) | A formulation (0.2 mm) | PE-foam layer (3 mm) |
| Example 4 | b formulation (0.5 mm) | B formulation (0.2 mm) | PE-foam layer (3 mm) |
| Comp. | b formulation (0.5 mm) | Hot-melt type adhesive (0.2 | PE-foam layer (3 mm) |
| Example 3 | | mm) | |
| Comp. | b formulation (0.5 mm) | Vinyl chloride type adhesive | PE-foam layer (3 mm) |
| Example 4 | | (N/A) | |

*a formulation: preparation, by blending 65 parts of plasticizer with 100 parts of PVC
*b formulation: preparation, by blending 105 parts of plasticizer with 100 parts of PVC
*A formulation: preparation, by blending 40 parts of plasticizer with 100 parts of EVA-PVC graft copolymer
*B formulation: preparation, by blending 70 parts of plasticizer with 100 parts of EVA-PVC graft copolymer
In Table 1, the thickness of the adhesive layer in Comparative Examples 2 and 4 is described as N/A since the adhesive layer is partially compatibilized with the S-PVC layer showing almost no thickness, which could not be measured.

Table 2 shows the result of a peeling test conducted to each of the test specimens. The test was conducted in accordance with “JIS K6854 (test method for the peeling strength of adhesive)”, in which the extent of peeling strength exerted on each of the test specimens till the specimen can maintain the lamination state was measured both in the initial stage (not yet deteriorated) and after leaving at 70° C. for 168 hours (upon deterioration), the larger value for the measured stress indicates that the specimen (laminate) is stronger with less peeling.

TABLE 2
Result of Peeling Test

| | Peeling strength: initial stage | | Peeling strength: after left at 70° C. for 168 | |
|---|---|---|---|---|
| | (not yet deteriorated ) | | hr (upon deterioration) | |
| | Between S-PVC/ | Between adhesive | Between S-PVC/ | Between adhesive |
| | adhesive layer | layer/PE-foam | adhesive layer | layer/PE-foam |
| Example 1 | 13.2 N/cm | 1.9 N/cm | 11.0 N/cm | 1.7 N/cm |
| | (material fractured) | (material fractured) | (material fractured) | (material fractured) |
| Example 2 | 8.8 N/cm | 1.8 N/cm | 7.1 N/cm | 1.7 N/cm |
| | (material fractured) | (material fractured) | (material fractured) | (material fractu red) |
| Comp. | 3.4 N/cm | 1.5 N/cm | 0.6 N/cm | 1.3 N/cm |
| Example 1 | (peeled) | (material fractured) | (peeled) | (material fractured) |
| Comp. | 1.0 N/cm | | 1.8 N/cm | |
| Example 2 | (peeled) | | (peeled) | |
| Example 3 | 8.9 N/cm | 1.8 N/cm | 12.1 N/cm | 1.6 N/cm |
| | (material fractured) | (material fractured) | (material fractured) | (material fractured) |
| Example 4 | 9.5 N/cm | 1.7 N/cm | 8..0 N/cm | 1.7 N/cm |
| | (material fractured) | (material fractured) | (material fractured) | (material fractured) |
| Comp. | 4.5 N/cm | 1.5 N/cm | 0.1 N/cm | 1.7 N/cm |
| Example 3 | (peeled) | (material fractured) | (peeled) | (material fractured) |

| | | |
|---|---|---|
| Comp. | 1.4 N/cm | 1.3 N/cm |
| Example 4 | (peeled) | (peeled) |

In Table 2, for the peeling strength of Comparative Examples 2 and 4, since the adhesive layer was so thin as could not be measured, only the data for peeling strength between S-PVC/PE-foam was described

As apparent from the result of the test, in the test specimens of Examples 1 to 4 corresponding to the laminate of the invention, the S-PVC layers and the adhesive layers were bonded favorably when compared with the test specimens of Comparative Examples 1 and 3 using hot melt type adhesives or test specimens of Comparative Examples 2 and 4 using vinyl chloride type adhesives. Further, the adhesion is maintained at a high level even after deterioration.

This means that in the laminate of the invention, the lamination state can be kept favorably even when undergoing external stresses such as friction or lateral displacement in the direction from the S-PVC layer to the PE-foam layer unless so much stress is applied as to fracture the cell structure of the PE-foam layer at the inside. Further, this also means that the S-PVC layer functions effectively as the protection cover for the PE-foam layer and that the effect is maintained for the long period of time.

On the contrary, in the test specimens using the hot melt type adhesives of Comparative Examples 1 and 3, lamination of the S-PVC layer can be kept in the initial stage but they show remarkable aging deterioration. Particularly, after deterioration, when external stresses such as friction or lateral displacement are exerted to the test specimens in the direction from the S-PVC layer to the PE-foam layer, the S-PVC layer is peeled before fracture of the cell structure of the PE-foam layer. In this case, the S-PVC layer can not function well as a protection cover for the PE-foam layer and can not be said practical.

Further, in the test pieces of Comparative Examples 2 and 4 using the vinyl chloride type adhesives, since the adhesive layer mainly comprises vinyl chloride, while adhesion between the adhesive layer and the S-PVC layer is high, the adhesion between the adhesive layer and the PE-foam layer is extremely low. In an actual test, when a stress is applied directly to the PE-foam layer, peeling occurs between the adhesive layer and the PE-foam layer by such an extent of force as distracting the cell structure.

This means that when external stresses such as friction or lateral displacement are exerted to the test specimen in the direction from the S-PVC layer to the PE-foam layer, the S-PVC layer is peeled together with the adhesive layer before the cell structure of the PE-foam layer is destroyed. In this case, the S-PVC layer can not function well as a protection cover for the PE-foam layer and it can not also be said practical.

Table 3 shows the result of a flexibility test conducted to each of the test specimens. The test was conducted by using a test equipment and test pieces specified in “JIS K7113 (plastic tensile test)”. Then, tensile stress required for extending each of the test specimens by 5% was measured. Smaller value for the measured stress indicates a more flexible test specimen (laminate).

TABLE 3
Result of flexibility test
At 5% elongation

| | | Comp. | Comp. | | | Comp. | Comp. |
|---|---|---|---|---|---|---|---|
| Example | Example | Example | Example | Example | Example | Example | Example |
| 1 | 2 | 1 | 2 | 3 | 4 | 3 | 4 |
| 7.0 N/cm | 6.1 N/cm | 8.2 N/cm | 7.0 N/cm | 5.0 N/cm | 4.4 N/cm | 5.3 N/cm | 3.5 N/cm |

As apparent from the result of the test, the test specimens of Examples 1 to 4 corresponding to the laminate of the invention are much more flexible compared with the test specimens of Comparative Examples 1 and 3 using the hot melt type adhesives. In addition, flexibility can be controlled by adjusting the addition amount of the plasticizer to the EVA-PVC graft copolymer.

In the test specimens of Comparative Examples 2 and 4 using the vinyl chloride type adhesives, the adhesive layer scarcely has thickness as shown in Table 1, which is a thickness about 90% or more of that of other test specimens. While lower numerical values are shown being caused by the small thickness, if the thickness of the adhesive layer could be increased to be identical with the thickness of other test specimens (actually, it is impossible since the adhesive layer contains a solvent and the solvent dissolves the S-PVC layer), it may be considered that much larger numerical values than the result of the test would be indicated by the hardness of the vinyl chloride resin as the main component of the adhesive layer.

In addition, as described above, the adhesive layer has only an extremely low adhesion relative to the PE-foam layer and it is considered that the layer is not practical.

From the foregoings, the test specimens of Examples 1 to 4, that is, only the laminate of the invention, while sufficiently soft and flexible, can effectively make the S-PVC layer functioned as the protection cover for the PE-foam layer and the functionality can be maintained for long period of time.

Further, as can be seen from the result of the test described above, the resin layer containing the EVA-PVC graft copolymer as the adhesives layer of Examples 1 to 4 has better adhesion with the PE-foam layer compared with the hot melt type adhesives or vinyl chloride type adhesives of Comparative Examples 1 to 4. Further, since they are also excellent in the flexibility, the resin layer containing the EVA-PVC graft copolymer per se can be functioned as a protection cover for the PE-foam layer.

What is claimed is

1. A laminate containing a foamed polyethylene resin in which a resin layer comprising a graft copolymer of an ethylene-vinyl acetate copolymer resin and a vinyl chloride resin is laminated to a foamed polyethylene resin layer.

2. A laminate containing a foamed polyethylene resin as defined in claim 1, wherein the thickness for said foamed polyethylene resin layer is larger than the thickness for said resin layer containing the graft copolymer.

3. A laminate containing a foamed polyethylene resin as defined in claim 1 or 2, wherein a resin layer containing an ethylene-vinyl acetate copolymer resin is interposed between said resin layer containing the graft copolymer and the foamed polyethylene resin layer.

4. A laminate containing a foamed polyethylene resin as defined in claim 1 or 2, wherein said resin layer containing the graft copolymer is a soft resin layer containing an appropriate amount of a plasticizer.

5. A laminate containing a foamed polyethylene resin comprising a foamed polyethylene resin layer and a vinyl chloride resin layer in which a resin layer containing a graft copolymer foamed of an ethylene-vinyl acetate copolymer resin and a vinyl chloride resin is interposed between both of the resin layers.

6. A laminate containing a foamed polyethylene resin as defined in claim 5, wherein the thickness for said foamed polyethylene resin layer is made larger than the thickness of the sum of the thickness for said vinyl chloride resin layer and that for the graft copolymer.

7. A laminate containing a foamed polyethylene resin as defined in claim 5 or 6, wherein a resin layer containing an ethylene-vinyl acetate copolymer is interposed between said resin layer containing the graft copolymer and the foamed polyethylene resin layer.

8. A laminate containing a foamed polyethylene resin as defined in claim 5 or 6, wherein said resin layer containing the graft copolymer is a soft resin layer containing an appropriate amount of a plasticizer.

9. A laminate containing a foamed polyethylene resin as defined in claim 5 or 6, wherein said vinyl chloride resin layer is a soft resin layer containing an appropriate amount of a plasticizer.

10. A laminate containing a foamed polyethylene resin as defined in claim 9, wherein said resin layer containing the graft copolymer has the same extent of flexibility as that of the vinyl chloride resin layer.
